(19) United States
(12) Patent Application Publication
(10) Pub. No.: US 2024/0171027 A1
(43) Pub. Date: May 23, 2024

(54) Rotor Shaft Assembly for an Electric Machine and Electric Machine

(71) Applicant: Bayerische Motoren Werke Aktiengesellschaft, Muenchen (DE)

(72) Inventors: Benjamin KRANK, Muenchen (DE); Joachim MAERZ, Holzkirchen (DE); Ignacio SERRAHIMA, Muenchen (DE); Bernhard WOLF, Muenchen (DE)

(21) Appl. No.: 18/282,563

(22) PCT Filed: Apr. 12, 2022
(86) PCT No.: PCT/EP2022/059745

§ 371 Date: Sep. 18, 2023

(30) Foreign Application Priority Data
May 7, 2021 (DE) 10 2021 111 906.5

(51) Int. Cl. H02K 1/32; H02K 9/19

(52) U.S. Cl. CPC H02K 1/32; H02K 9/19

(57) ABSTRACT

A rotor shaft assembly for an electric machine, comprising a hollow rotor shaft which is designed to accommodate a rotor and delimits a hollow space that is designed such that a cooling medium can flow through in order to cool the rotor shaft, and comprising a lance projecting into the hollow space, which has an out-flow region, via which the cooling medium guided in the lance can flow out of the lance and into the hollow space, and in which the lance has a swirling device, with which turbulence can be generated in the cooling medium when same is flowing out of the lance.

### FIELD

The invention relates to a rotor shaft assembly for an electric machine, in particular of a motor vehicle, and to an electric machine.

### BACKGROUND AND SUMMARY

DE 10 2015 214 309 A1 discloses a hollow shaft cooling means for a drive of an electric vehicle, the drive having an electric motor and a transmission which is connected to a rotor hollow shaft of the electric motor for the transmission of torque. A hollow lance is arranged in the rotor hollow shaft, which hollow lance is configured in such a way that it can discharge a coolant into a cavity of the rotor shaft. The hollow lance has a cooling opening at its end which is remote from the transmission.

Furthermore, U.S. Pat. No. 7,489,057B2 has disclosed a cooling system for a rotor assembly with a rotor shaft. A part of the rotor shaft is of hollow configuration, a coolant feed pipe being fastened rigidly to the rotor shaft via one or more supporting elements. As a result, the rotor shaft and the coolant feed pipe rotate at an identical speed. Coolant is pumped through the coolant feed pipe until it exits at the end of the coolant feed pipe and flows against an inner surface of the hollow rotor shaft, on which inner surface the coolant is deflected.

Furthermore, WO 2018/137955 A1 has disclosed an electric machine with a rotor arranged fixedly on a rotor shaft for conjoint rotation, and a rotor. An axial coolant supply line and at least one radial coolant supply line which is connected to the axial coolant supply line so as to conduct coolant are arranged in the rotor shaft. The rotor is configured as a laminated rotor, and the radial coolant supply line is connected so as to conduct coolant to at least one lamination intermediate space of the laminated rotor.

It is an object of the present invention to provide a solution, by means of which coolant which is conducted via a lance into a cavity of a rotor shaft can be distributed over an inner wall of the cavity of the rotor shaft in such a way that as high a heat transfer as possible can be made possible between a warm rotor shaft and a cold fluid.

According to the invention, this object is achieved by way of the subject matter of the present disclosure. Further possible embodiments of the invention are disclosed in the description and the figures.

The invention relates to a rotor shaft assembly for an electric machine which is configured, in particular, to drive a motor vehicle with electric energy. The rotor shaft assembly comprises a hollow rotor shaft which is configured to receive a rotor group to be cooled. Furthermore, the rotor shaft delimits a cavity which is configured, for cooling the rotor shaft, to be flowed through by a cooling medium. Furthermore, the rotor shaft assembly comprises a lance which protrudes into the cavity and has an outflow region, via which the cooling medium which is conducted in the lance can flow out of the lance into the cavity. Therefore, the cooling medium can be conducted via the lance centrally into the cavity of the hollow rotor shaft and, as a result, comes directly into contact with inner surfaces to be cooled of the rotor shaft. In the outflow region, the lance has a targeted diverting or swirling device, via which the outflow direction or turbulence can be imparted in a targeted manner to the cooling medium when flowing out of the lance. In other words, when flowing out of the lance, the cooling medium is introduced into the cavity of the hollow rotor shaft with imparted turbulence by means of the swirling device. As a result of the imparting of the turbulence to the cooling medium by means of the swirling device when the cooling medium flows out of the outflow region of the lance, the cooling medium can be distributed over a particularly large area onto an inner surface, delimiting the cavity, of the hollow rotor shaft. As a result, particularly high and at the same time large-area cooling of the hollow, warm rotor shaft can take place. The lance can be, in particular, a lance which is stationary relative to the rotor shaft which rotates about a center axis. As a result, furthermore, a particularly homogeneous application of the cooling medium to the inner surface of the rotor shaft can be made possible via a relative movement of the rotor shaft with respect to the stationary lance. The application of the turbulence on the cooling medium when flowing out of the lance makes it possible, moreover, that the cooling medium which comes into contact with the inner surface of the rotor shaft has the turbulence, as a result of which a particularly great heat transfer takes place between the rotor shaft and the cooling medium, and therefore particularly satisfactory cooling of the rotor shaft by way of the cooling medium takes place.

It is provided in one development of the invention that the lance comprises, as the swirling device, at least one opening which is arranged in a pipe wall of the lance and via which the cooling medium can flow radially out of the lance. In particular, the lance can have a plurality of openings in the pipe wall, via which openings the cooling medium can flow radially out of the lance. Here, the plurality of openings can be arranged symmetrically with respect to one another or asymmetrically with respect to one another. Via the at least one opening, the cooling medium can therefore exit the lance laterally, as a result of which the cooling fluid is set in turbulence due to a kink in a flow direction along the longitudinal extent direction of the lance through the opening of the pipe wall. This increased swirling of the cooling medium makes a particularly homogeneous application of the cooling medium to the inner surface of the rotor shaft possible, and makes a particularly satisfactory heat transfer from the rotor shaft to the cooling medium on account of the turbulence of the cooling medium possible.

In a further refinement of the invention, it has been shown to be advantageous if the at least one opening is configured as a slot. The configuration of the at least one opening as a slot makes it possible for a particularly large amount of cooling medium to exit the lance at an ejection angle which is predefined by way of geometry of the slot. Via a respective number, arrangement and geometry of slots, the wetting of the inner surface of the rotor shaft with the cooling medium can be adjusted particularly satisfactorily.

It is provided in a further refinement of the invention that the at least one opening is provided by way of a passage in the pipe wall, the center axis of which passage is oriented obliquely with respect to a center axis of the lance. Here, the center axis of the opening encloses an angle with the center axis of the lance which does not equal 90°. Via a selection of the respective angle which the center axis of the opening encloses with the center axis of the lance, an outflow angle of the cooling medium from the lance to the inner surface of the rotor shaft can be predefined particularly precisely. As a result, respective regions of the rotor shaft which are to be flowed onto by the cooling medium can be predefined particularly simply and precisely.

It is provided in a further refinement of the invention that, in addition to the at least one opening which is arranged in the pipe wall of the lance, the lance has, at its free end, at least one further outlet opening, via which the cooling medium can flow axially out of the lance. This means that the cooling medium can flow radially out of the lance via the at least one opening, and the cooling medium can flow axially out of the lance via the further outlet opening. As a result, when flowing out of the lance, the cooling medium can flow away from the lance in a particularly large number of different directions, as a result of which the inner surface of the rotor shaft can be cooled particularly homogeneously with cooling medium which comes directly from the lance.

In this context, it can be provided, in particular, that the at least one outlet opening has a constricted cross section in comparison to a guide region of the lance, through which guide region the cooling medium is to be conducted within the lance to the outflow region. This means that the outlet opening can be part of a nozzle device in the region of the outflow region of the lance. The turbulence can be imparted to the cooling medium by way of the constriction of the cross section of the lance from the guide region as far as the outlet opening. The constricted cross section of the outlet opening in comparison with the guide region of the lance makes throttling of the cooling medium possible, as a result of which the cooling medium can be accelerated and possibly swirled. The constricted cross section of the outlet opening in comparison with the guide region makes particularly simple accelerating and/or swirling of the cooling medium when exiting the lance via the outlet opening possible.

It is provided in a further refinement of the invention that at least two openings are provided in the outflow region of the lance, which openings have an axial spacing of different length with respect to one another from the free end of the lance. In other words, the at least two openings are arranged in front of one another or behind one another along the longitudinal extent direction of the lance. As a result, a particularly great region of the inner surface of the rotor shaft can be wetted with the cooling medium which exits from the lance.

It is provided in a further refinement of the invention that the at least one opening is provided by way of an incision in the pipe wall, the lance being constricted at its free end by way of a pinched portion. These openings can be provided, in particular, by means of the lance being cut on both sides and a front segment, in particular a free end of the lance, subsequently being pressed in, as a result of which an oblique channel can be produced and, at the same time, a constriction of the outlet opening can be achieved. By way of the pinched portion, in particular, the outlet opening can be provided with an oval cross section. By way of the cutting and pinching of the lance, the swirling device can be provided particularly simply despite a complex geometry.

It is provided in a further refinement of the invention that the swirling device is provided by way of a swirling element which is plugged into the lance. Here, the swirling element can be plugged into the lance, in particular, at the free end of the lance, in particular on a region which is included by the outflow region. The swirling element can be plugged, in particular, into an inner channel of the lance, as a result of which the swirling element can receive cooling medium conducted in the inner channel, can swirl it, and can subsequently guide it out of the lance. The swirling element which is plugged into the lance makes it possible that the lance and the swirling element can be produced separately. As a consequence, the geometry of the swirling element can be adjusted particularly precisely, as a result of which in turn swirling of the cooling medium brought about by way of the swirling element can be adjusted particularly precisely.

The invention relates, furthermore, to an electric machine, in particular for a motor vehicle, with a stator, a rotor and a rotor shaft assembly as has already been described in conjunction with the rotor shaft assembly according to the invention. This rotor shaft assembly comprises a hollow rotor shaft, on which the rotor is held. Advantages and advantageous developments of the rotor shaft assembly according to the invention are to be considered to be advantages and advantageous developments of the electric machine, and vice versa.

Further features of the invention can result from the claims, the figures and the description of the figures. The features and combinations of features mentioned above in the description and the features and combinations of features shown in the following text in the description of the figures and/or shown solely in the figures can be used not only in the respective specified combination, but rather also in other combinations or on their own, without departing from the scope of the invention.

### BRIEF DESCRIPTION OF THE DRAWINGS

FIG. 1 shows a diagrammatic cross section of a rotor shaft assembly for an electric machine, with a hollow rotor shaft, by which a rotor can be received fixedly for conjoint rotation, and with a lance which is stationary relative to the rotor shaft and via which a coolant can be fed into a cavity which is enclosed by the rotor shaft, it being possible for the coolant to flow out of the lance via an outflow region of the lance and to flow into the cavity,

FIGS. 2a, 2b, and 2c show respective sectional views of the cavity enclosed by the rotor shaft and of the lance protruding into the cavity, the lance comprising, in the outflow region, a swirling device, by means of which cooling medium flowing out of the lance can be swirled, the swirling devices being shown in FIGS. 2a to 2c in different embodiments, and

FIGS. 3a, 3b show a diagrammatic sectional view of the outflow region of the lance with the swirling device in a further embodiment, in the case of which a pipe wall of the lance is cut on opposite sides and a free end of the lance is constricted by way of a pinched portion.

### DETAILED DESCRIPTION

In the figures, identical and functionally identical elements are provided with the identical designations.

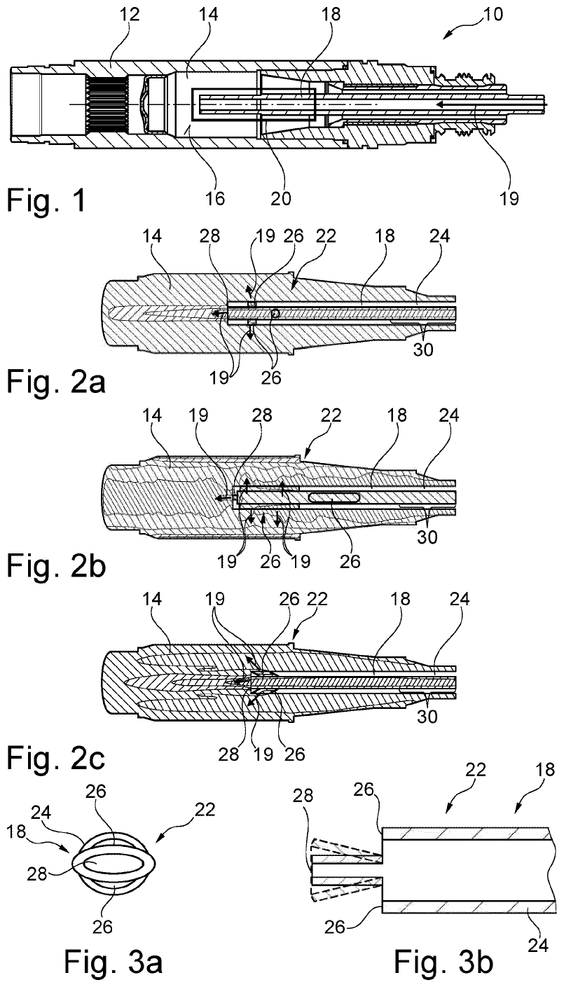

FIG. 1 shows a diagrammatic sectional view of a rotor shaft assembly 10 for an electric machine of a motor vehicle. The motor vehicle can be driven by means of this electric machine. The rotor shaft assembly 10 comprises a hollow rotor shaft 12, by which a rotor of the electric machine can be received. In particular, a rotational axis of the rotor can be predefined by way of the rotor shaft 12. The rotor shaft 12 encloses a cavity 14 which can be flowed through by a cooling medium 19. When the cooling medium 19 flows through the cavity 14, the cooling medium 19 can absorb heat from the rotor shaft 12, as a result of which the rotor shaft 12 can be cooled.

In order to bring about a particularly satisfactory cooling effect of the cooling medium 19 on an inner surface 16 of the rotor shaft 12, the rotor shaft assembly 10 in the present case comprises a lance 18 which protrudes into cavity 14 and is configured to conduct the cooling medium 19 directly to the inner surface 16 to be cooled of the rotor shaft 12. The lance 18 is configured in the present case as a stationary water lance which is configured to conduct water as cooling medium 19 for water cooling of the rotor shaft 12 into the cavity 14. The stationary embodiment of the lance 18 is to be understood to mean that, during operation of the electric machine which comprises the rotor shaft assembly 10, the rotor shaft 12 is rotated about a rotational axis relative to the lance 18.

The lance 18 has an outflow region 20, via which the cooling medium 19 which is conducted in the lance 18 can flow out of the lance 18 into the cavity 14. In the outflow region 20, the lance 18 has a swirling device 22, by means of which the cooling medium 19 can be swirled while flowing out of the lance 18 and therefore can be provided with turbulence. As a result of the swirling of the cooling medium 19 by means of the swirling device 22 of the lance 18, particularly homogeneous wetting of the inner surface 16 of the rotor shaft 12 with the cooling medium 19 is firstly made possible, and a flow of the cooling medium 19 along the inner surface 16 of the rotor shaft 12 with swirling and therefore turbulence is secondly made possible, as a result of which a particularly satisfactory heat transfer between the rotor shaft 12 and the cooling medium 19 and, as a consequence, particularly satisfactory cooling of the rotor shaft 12 can be achieved.

Different embodiments of the swirling device 22 are shown in FIGS. 2a, 2b, 2c and 3a and 3b. As is shown in FIGS. 2a to 3b, the swirling device 22 can comprise at least one opening 26 which is arranged in a pipe wall 24 of the lance 18, it being possible for the cooling medium 19 to flow out of the lance 18 into the cavity 14 via this at least one opening 26. In addition to the at least one opening 26, the lance 18 can have at least one outlet opening 28 in the outflow region 20. Via this at least one outlet opening 28 which is arranged at the free end of the lance 18, the cooling medium 19 can flow axially out of the lance 18. As is shown in FIG. 2a and FIG. 2c, this outlet opening 28 can have a cross section which corresponds to the cross section of the lance 18 in a guide region 30 of the lance 18. In the guide region 30 of the lance 18, the cooling medium 19 is to be conducted within the lance 18 to the outflow region 20. As an alternative, as is shown in FIG. 2b and in FIG. 3a, the at least one outlet opening 28 can have a constricted cross section in comparison with the guide region 30 of the lance 18. As a result, a throttling action can occur when the cooling medium 19 exits the lance 18, as a result of which the cooling medium 19 which exits the lance 18 in the axial direction can be swirled.

All of the embodiments of openings 26 described in the following text can be combined freely with the described embodiments of outlet openings 28. As can be seen in FIG. 2a, the swirling device 22 can have a plurality of openings 26 which are provided by way of radial bores in the pipe wall 24 of the lance 18. The plurality of openings 26 can be arranged behind one another along a flow direction of the cooling medium 19 through the lance 18, as a result of which the cooling medium 19 which exits the lance 18 can be distributed over a particularly great area of the inner surface 16 of the rotor shaft 12. As is shown in FIG. 2a, these radial bores can be oriented with their center axis at least substantially perpendicularly with respect to a longitudinal extent direction of the lance 18 or, as is shown in FIG. 2c, with their center axis obliquely with respect to the longitudinal extent axis of the lance 18. As an alternative to the provision of the openings 26 by way of radial bores, at least one of the openings 26 of the swirling device 22 can be provided by way of a radial slot in the pipe wall 24 of the lance 18, as is shown in FIG. 2b. Here, a center axis of the slot can be oriented perpendicularly with respect to the longitudinal extent direction of the lance 18 or obliquely with respect to the longitudinal extent direction of the lance 18.

The swirling device 22 which is shown in FIGS. 3a and 3b is provided by way of cutting of the pipe wall 24 of the lance 18 on opposite sides and pinching of the free end of the lance 18. As a result of the pinching of the free end of the lance 18, the free end of the lance 18 is constricted. On account of this constriction of the free end of the lance 18, the outlet opening 28 can be of tapered configuration in cross section in comparison with the guide region 30 of the lance 18. FIG. 3a shows a frontal plan view of the free end of the lance 18, whereas FIG. 3b shows a longitudinal section of the lance 18 in the outflow region 20. Here, a pinched portion which is homogeneous over the length of the free end is shown using solid lines. An alternative single-sided pressed-in portion or pinched portion which faces the cuts of the pipe wall 24 is shown using dashed lines. This single-sided pressed-in portion results in a kinked (slightly angled in the present case) and therefore deflected fluid exit of the cooling medium 19 from the lance 18.

For a stationary embodiment of the lance 18 relative to the rotor shaft 12, the lance 18 can be pressed into a cover of the electric machine. As an alternative, the lance 18 can be fixed for conjoint rotation relative to the rotor, in particular relative to the rotor shaft 12.

In a manner which is dependent on respective adjusting parameters for volumetric flow control and directional control of the cooling medium 19, requirements of the openings 26 such as angle, opening size and number can be predefined, in order to cool the inner surface 16 of the rotor shaft 12 as satisfactorily as possible. The described embodiments of swirling devices 22 can be combined with a throttle at the free end of the lance 18, as a result of which volumetric flows in the openings 26 can be controlled. The throttle can be provided, in particular, by way of an insert part or a roll-formed machined portion of the free end of the lance 18.

The described rotor shaft assembly 10 is based on the finding that hollow shaft cooling for cooling a rotor of electric drive machines is frequently realized by way of a lance cooling means, in the case of which the cooling medium 19 is conveyed in a stationary lance 18 into the hollow rotor shaft 12 of the electric machine, and the cooling medium 19 cools the rotating rotor shaft 12 and therefore the rotor from the inside there. Here, the cooling medium 19 can flow out of the rotor shaft 12 at one end over a particularly great diameter. In the case of a typically used smooth pipe as stationary water lance, there can be the problem that inflowing cooling medium 19 flows out of the water lance centrally and therefore axially, and can be deflected only at the end of a fluid space, in particular the cavity 14, in order that the cooling medium 19 can then cool the inner surface 16 of the rotor shaft 12 when flowing back. This can lead to a heat transfer between the cooling medium 19 and components to be cooled being concentrated greatly to a deflection region and leading to an inhomogeneous temperature distribution in the rotor shaft 12. Here, in comparison with the described rotor shaft assembly 10, a potential of a heat transfer cannot be exhausted completely, with the result that cooling performance might not be sufficient and this is to be compensated for by way of higher volumetric flows of the cooling medium 19 or a lower temperature of the cooling medium 19. The latter can lead to particularly high costs of a cooling system.

The described rotor shaft assembly 10 makes a particularly advantageous heat transfer between the rotor shaft 12 and the cooling medium 19 possible, in particular in comparison with longer lance geometries.

The rotor shaft assembly 10 firstly makes a particularly advantageous cooling distribution of the cooling medium 19 possible by way of adaptation on the stationary lance 18 by way of geometrically adjustable volumetric flow direction starting from the stationary lance 18 and, furthermore, the rotor shaft assembly 10 makes a generation of a swirled flow of the cooling medium 19 possible, which swirled flow results in a particularly high heat transfer and, as a consequence, a particularly satisfactory cooling effect of the rotor shaft 12 and of the rotor.

The stationary lance 18 can be manufactured from a pipe, through which the cooling medium 19 can be conducted into the cavity 14 of the rotor shaft 12. Instead of or in addition to a classic outlet geometry of an open pipe, the pipe opening is depicted in different geometrical embodiments, in order to deflect an actively conveyed volumetric flow of the cooling medium 19 as required from a stationary part of the lance 18 onto the rotating inner surface 16 of the rotor shaft 12. A very simple form of the swirling device 22 can be respective openings 26 which are provided by way of one or more bores which are made on the stationary lance 18 behind one another or offset angularly. As an alternative, the openings 26 can be configured as slots. Furthermore, openings 26 are possible as an alternative which are provided by way of single-sided cutting and pressing of the lance 18 from the opening side, which results in an oblique opening 26 which faces away, for example by 30°, from an original pipe opening, the outlet opening 28 in the present case. As an alternative to symmetrically made openings 26, asymmetrical fluid outlets are conceivable, in order to achieve a particularly advantageous swirling effect. By way of a selected type of the at least one opening 26 in combination with its number, position and a length of the lance 18, a fluid jet concentration of the actively pumped cooling medium 19 can therefore be controlled, and particularly high swirling can be brought about. These measures lead overall to particularly advantageous cooling of the rotor shaft 12 at its points which require cooling. As an alternative or in addition, the at least one opening 26 can be provided by way of parts (in particular, a swirling element) pressed into the pipe which provides the lance 18, as a result of which the provision of the swirling device 22 is not bound to the machining of the pipe. By way of a constriction or closure of the outlet opening 28, in particular of an original pipe outlet of the pipe, the parallel volumetric flow through the openings 26 can be adjusted. This constriction or closure of the outlet opening 28 can take place by way of a plug or a sleeve being pressed in, or by way of deforming and/or pinching of an open pipe end of the pipe which provides the lance 18.

Overall, the present disclosure shows how an improvement in an outflow geometry of a stationary cooling lance (in the present case, the lance 18) can be achieved in the case of a hollow shaft cooling means for electric drive machines.

### LIST OF DESIGNATIONS

10 Rotor shaft assembly
12 Rotor shaft
14 Cavity
16 Inner surface
18 Lance
19 Cooling medium
20 Outflow region
22 Swirling device
24 Pipe
26 Opening
28 Outlet opening
30 Guide region

1-10. (canceled)

11. A rotor shaft assembly for an electric machine, the rotor shaft assembly comprising:
a hollow rotor shaft configured to receive a rotor and delimit a cavity, which, in order to cool the rotor shaft, is configured to have a cooling medium flow therethrough; and
a lance which protrudes into the cavity and has an outflow region, via which the cooling medium which is conducted in the lance can flow out of the lance into the cavity, and in which the lance comprises a swirling device, via which turbulence can be applied to the cooling medium during the flow out of the lance.

12. The rotor shaft assembly according to claim 11,
wherein the lance comprises, as the swirling device, at least one opening which is arranged in a pipe wall of the lance and via which the cooling medium can flow radially out of the lance.

13. The rotor shaft assembly according to claim 12,
wherein the at least one opening is configured as a slot.

14. The rotor shaft assembly according to claim 12,
wherein the at least one opening is provided by way of a passage in the pipe wall, a center axis of which passage is oriented obliquely with respect to a center axis of the lance.

15. The rotor shaft assembly according to claim 12,
wherein, in addition to the at least one opening which is arranged in the pipe wall of the lance, the lance has, at its free end, at least one further outlet opening, via which the cooling medium can flow axially out of the lance.

16. The rotor shaft assembly according to claim 15,
wherein the at least one outlet opening has a constricted cross section in comparison to a guide region of the lance, through which guide region the cooling medium is to be conducted within the lance to the outflow region.

17. The rotor shaft assembly according to claim 12,
wherein at least two openings are provided, which have an axial spacing of different length with respect to one another from the free end of the lance.

18. The rotor shaft assembly according to claim 12,
wherein the at least one opening is provided by way of an incision in the pipe wall, the lance being constricted at its free end by way of a pinched portion.

19. The rotor shaft assembly according to claim 11,
wherein the swirling device is provided by way of a swirling element which is plugged into the lance.

20. An electric machine comprising:
a stator;
a rotor; and
a rotor shaft assembly according to claim 11, wherein the rotor is held on the hollow rotor shaft.
